(19) United States
(12) Patent Application Publication
(10) Pub. No.: US 2020/0215473 A1
(43) Pub. Date: Jul. 9, 2020

(54) AIR PURIFICATION PLANT WITH INTEGRATED FILTER CLEANING DEVICE

(71) Applicant: LUWA AIR ENGINEERING AG, Uster (CH)

(72) Inventors: André REMSCHAK, Hittnau (CH); Juergen WEHNER, Wetzikon (CH)

(73) Assignee: LUWA AIR ENGINEERING AG, Uster (CH)

(21) Appl. No.: 16/638,008

(22) PCT Filed: Aug. 17, 2017
(86) PCT No.: PCT/EP2017/070826

§ 371 Date: Feb. 10, 2020

(51) Int. Cl. B01D 46/00; B01D 46/12

(52) U.S. Cl. CPC B01D 46/0065; B01D 46/125; B01D 46/0005

(57) ABSTRACT

An air purification plant has a partition for spatially separating a contaminated air chamber arranged upstream from a clean air chamber downstream, the partition including a support frame and multiple filter boxes projecting from the support frame, the filter boxes having at least one filter box wall which extends from the support frame into the contaminated air chamber. The filter boxes are each open into the clean air chamber arranged downstream, wherein filter box walls, facing toward one another, of adjacent filter boxes form in each case one filter pocket which is open at the upstream side and preferably at the top and/or bottom, and a suction nozzle is movable from one filter pocket into an adjacent filter pocket. At the downstream side, each filter pocket has a pocket base portion which is at least approximately impermeable to air and has a smooth surface on the contaminated air side.

The present invention relates to an air purification plant according to claim 1.

The use of air purification plants is of great importance in particular in the textile industry since large amounts of dust and lint are released into the air when producing textile products. When such contaminations settle on the textile yarn, this has a significant negative influence in terms of the quality of the textile products manufactured. For this reason, filter plants for relieving the air of entrained dust and material particles are usually used in textile manufacturing sites. Such filter installations usually fill a room and have filter walls which are several meters high and have filter mats which are passed through by a flow of the air to be purified. The dust and fiber particles entrained in the contaminated air are thus separated on the filter mats. However, the deposited quantity of the separated particles, which increases in the course of the service life of the air purification device, is associated with a decrease in terms of the permeability of the filters. In order for a consistent filter output to be able to be guaranteed, the filter faces therefore have to be cleaned, or relieved of deposited dust and fiber materials at regular intervals, respectively. Known cleaning possibilities are, for instance, reverse purging, or counterflow blowing, respectively, scraping, beating, or vacuuming the filter faces.

For example, a scraper which for cleaning the filter face is moved up and down along the surface of the latter, so as to wipe off the particles deposited on the filter face and to convey said particles into a receptacle chamber lying therebelow, is disclosed in DE 3 525 656 A1.

However, such scrapers have proven disadvantageous for air purification plants in the textile industry, since fibers entrained in the air flow, by virtue of electrostatic charging or solely on account of being transported in the air through ducts or pipelines, build up so as to form comparatively large accumulations, so-called fiber tails, fiber tufts, fiber balls, or fiber strands. Said accumulations often adhere to the scraper, this heavily impeding the functionality of the latter.

For this reason, suction devices which are moved along the filter faces so as to suction the deposited contaminants from the filter faces are increasingly used in the textile industry.

A filter device which has a trap device having a plurality of V-shaped niches which are effective as filters is disclosed in DE 3830461, for instance. In order for the niches to be cleaned, the suction nose of a suction member attached to a support is introduced into the front side of a niche and is moved up and down therein. Either a dedicated suction member is assigned to each niche, or one suction member is assigned for cleaning a plurality of niches, and after the cleaning of a niche is reversed out of the latter, outside the trap device is moved laterally in a horizontal manner to a next niche, and with the suction nose leading is moved forward and introduced into the next niche. The suction members, or the supports thereof, respectively, for cleaning the niches and changing from one niche to the next are thus moved in three spatial directions, specifically up and down in the vertical direction within the niches, forward and backward in the horizontal direction, as well as in a reciprocating lateral manner. In order for such multi-dimensional motion sequences be able to be implemented, not only complex designs in terms of construction but also complicated drive and control systems are required. Moreover, a lot of space for maneuvering the suction member from one niche to the next is required outside the filter niches of the trap device.

An air purification plant in which a suction nozzle below the filter pockets can be moved from one filter pocket to a neighboring filter pocket and the movement of the nozzle, on account thereof, can be reduced to two dimensions, is therefore proposed in WO 1816/091970 A1 filed in the name of the applicant.

A further problem in the context with suction installations in air purification plants is based on the fact that excessive fiber and dust accumulations arise over time in particular at locations which are not or are only poorly accessible to the suction nozzles, said fiber and dust accumulations potentially leading to congestion and thus to the suction nozzle being blocked.

It is therefore an object of the present invention to provide an air purification plant which is simplified in terms of construction and control and has a better or larger, respectively, filter capacity to space requirement ratio, permits reliable cleaning of the filter during operation, and in which fiber and dust accumulations on the filter faces can be reduced or easily removed, respectively.

This object is achieved by an air purification plant which has the features of claim 1. Preferred embodiments of the invention are the subject matter of the dependent claims.

The air purification plant according to claim 1 has a partition wall which is provided for spatially separating a contaminated air chamber, disposed upstream, from a clean air chamber, disposed downstream. The terms “upstream” and “downstream” in the present application refer at all times to the direction of the airflow which from sides of the contaminated air chamber flows through filter-active portions of the partition wall into the clean air chamber.

The partition wall comprises a support frame that defines a longitudinal plane, and a plurality of filter boxes that project from the support frame in the direction of the contaminated air chamber. Said filter boxes have in each case at least one, preferably two, filter box wall or filter box walls, respectively, that projects/project from the support frame in the direction of the contaminated air chamber and is/are open into the clean air chamber disposed downstream. The filter boxes are preferably open only on the rear side, thus into the clean air chamber, while said filter boxes upstream are delimited by filter box walls, and at the top and at the bottom are delimited by an upper or lower, respectively, preferably air-tight cover.

The filter box walls support in each case at least one filter mat (wherein two filter box walls can also support one common filter mat). The filter mats in the context of the present invention serve for purifying the air, this meaning that said filter mats at least in locations are permeable to air. Such filter mats are well known to the person skilled in the art and may comprise, for example, a metallic or textile woven fabric (in particular a fibrous non-woven, a needle felt fabric, and a pile fabric) or any other air-permeable filter-active substrate on which the contaminants such as fibers, dust particles or the like are separated from the air to be filtered on the upstream side of said substrate.

The regions of the filter mats which in the operation are passed through by a flow of air define the “filter-effective” or “filter-active” faces (or “filter faces” for short) of the air purification plant. With the exception of said filter faces, the contaminated air chamber is typically separated from the clean air chamber in a sealing, thus air-impermeable, manner by the partition wall. By virtue of the partition wall, air from the contaminated air chamber can thus make its way into the clean air chamber only through the filter faces. In the simplest of cases, the contaminated air chamber and the clean air chamber are disposed in a common box which is positioned on a continuously or at least partially open floor area which is configured, for example, as a (mesh) grate. The support frame of the partition wall in this case preferably defines the external circumference of the partition wall and in terms of the width and height thereof corresponds to the width and the height of the box. The support frame can thus be assembled so as to be perpendicular on the floor area, on account of which said support frame on the lower side is delimited by the floor area, on the upper side is delimited by the ceiling, and on both sides is delimited by the side walls of the box.

In the air purification plant according to the invention, air polluted with dust and fibers is directed from the contaminated air chamber through the filter mats into the clean air chamber, wherein the entrained dust and fiber materials are separated on the filter mats. “Directed” in this context means that an air flow is generated by virtue of a pressure differential between the contaminated air chamber and the clean air chamber, for example. To this end, the clean air chamber can be connected, for example, to a low-pressure source, for example a ventilator.

According to the invention, the filter boxes are disposed on the support frame of the partition wall in such a manner that mutually facing filter box walls of neighboring filter boxes form in each case one filter pocket. A filter pocket thus typically extends from the lower end in the vertical direction to the upper end of the filter boxes and has a depth measured perpendicularly to the longitudinal plane. According to the invention, the filter pockets are open on the upstream side, thus in the direction of the contaminated air chamber, while said filter boxes on the downstream side, thus in the direction of the clean air chamber, are delimited by the filter box walls of neighboring filter boxes as well as optionally by the support frame. Depending on the disposal and the shape of the filter box walls, filter pockets which in the cross section are trapezoidal, V-shaped, or U-shaped are formed. The filter-effective face is thus significantly larger than would be the case in a single planar filter wall.

According to one particularly preferred embodiment, the filter mats are fastened to a self-supporting frame which is preferably part of the filter box wall and optionally is additionally reinforced by connection struts. Such a frame construction as the support for the filter mats in comparison to the otherwise usual supports from expanded metal has the advantage that the available net filter face can be increased.

The air purification plant furthermore comprises a filter cleaning installation having a horizontal rail on which a carriage is guided so as to be movable in a reciprocating manner in the horizontal direction, as well as a vertical rail which is fastened to the carriage. A suction nozzle for cleaning the filter mats in a respective filter pocket is guided so as to be movable in a reciprocating manner in the vertical direction, and is furthermore movable from one filter pocket to a neighboring filter pocket. The filter cleaning installation is typically disposed in the contaminated air chamber.

The horizontal rail usually extends so as to be parallel with the support frame, and the vertical rail is normally disposed upstream of the partition wall or the filter boxes, respectively. Proceeding from the vertical rail, the suction nozzle by way of the free end thereof protrudes into a filter pocket and at the opposite other end is typically connected to a low-pressure source by way of a flexible air discharge line, for example an exhaust air hose. The suction nozzle for cleaning the filter mats in the respective filter pocket has one suction opening or a plurality of suction openings by way of which filtered material (for instance fiber material and dust) that has been separated on the filter mats can be suctioned off.

In the air purification plant according to the invention, the filter pockets have in each case one downstream-side, at least almost air-impermeable pocket bottom portion which is defined by a pocket base as well as two legs that from the pocket base project in each case along a respective filter box wall in the direction of the contaminated air chamber, and which extends across the entire height of the respective filter pocket.

By virtue of the at least almost air-impermeable properties of the pocket bottom portion, this region of the filter pocket which is typically poorly accessible to the suction nozzle is not filter-active; to this extent, there is no or only little airflow passing therethrough. This prevents fiber material being suctioned and adhering in the region of the pocket bottom, on account of which the quantity of filtered material accumulating thereon can be heavily reduced.

It has furthermore been demonstrated that filtered material in the pocket bottom does not only increasingly accumulate on the pocket base per se, but also on the wall portions of the filter pocket that are contiguous to the pocket base. In order for these accumulations to be reduced, according to the invention these portions which are contiguous to the pocket base are also part of the at least almost air-impermeable pocket bottom portion and are defined as “legs” of the latter. According to the invention, the legs are at least the length of the spacing between the filter box walls that form the respective filter pocket, said spacing being measured parallel with the longitudinal plane at the pocket base.

The term “measured along the pocket base” herein means that the spacing of the filter box walls is measured along a straight line which runs so as to be parallel with the longitudinal plane and either along the pocket base, or in the case of a curved pocket base forms the tangent of the latter. The pocket base herein does not mandatorily have to be disposed at the height of the downstream-side ends of the filter box walls but can also be offset further upstream. In the latter case, the depth of the filter pocket, the distance of the upstream-side end of a filter pocket to the filter pocket base, said distance being measured orthogonally to the longitudinal plane, is shorter than the depth of a filter box.

The legs of the pocket bottom portion are in each case particularly preferably at least 10%, more preferably at least 20%, more preferably at least 45%, particularly preferably at least 85%, longer than the above-mentioned spacing between two filter box walls at the pocket base. “The length of the legs” means in each case the length of an individual leg. When the legs are, for example, 25% longer than the spacing and the latter is of the length d, then each of the two legs has in each case a length of 125%×d. Depending on the shape of the filter pockets (U-shaped or V-shaped cross section) leg lengths of 150% of the spacing and longer are advantageous. In particular in comparatively narrow filter pockets which widen towards the upstream-side end (and have an acute opening angle), the legs can also be at least twice the length of the spacing between two filter box walls at the pocket base.

The overall length of the air-impermeable pocket bottom portion, that is to say the length measured across the two legs and the pocket bottom, is preferably at least 15 mm, preferably 50 mm to 300 mm, more preferably 70 mm to 200 mm, furthermore preferably approximately 100 mm to 160 mm.

In one particularly preferred embodiment, the legs are in each case approximately 2.5 to 3 times the length of the spacing of the filter box walls that form the filter box at the pocket bottom. In one specific example, the spacing of the filter box walls at the pocket bottom would be approximately 23 mm, and the two legs would in each case be approximately 65 mm. These dimensions have proven particularly advantageous in terms of an ideally minor accumulation of dust in the pocket bottom, and the accessibility of the filter pockets for the suction nozzle. As has been mentioned above, the filter pockets in the pocket bottom portion are at least almost air-impermeable. On account thereof, the filter pockets in the region of the pocket bottom portion are not filter-active, and significantly less filtered material accumulates on the contaminated-air-side surface of the filter pocket within the pocket bottom portion.

In order for fibers and dirt particles present in the contaminated air to ideally not adhere to the contaminated-air-side surface of the filter pocket in the region of the pocket bottom portion, said surface is preferably as “smooth” as possible. The contaminated-air-side surface of the filter pocket in the region of the pocket bottom portion therefore particularly preferably has a lower area-specific roughness value Sₐ (definition according to DIN EN ISO 25178) than the filter-active contaminated-air-side surfaces of the filter pocket outside the pocket bottom portion. Thanks to a “smooth surface”, at least part of the filtered material accumulated in the pocket bottom portion drops from the surface in a self-acting manner. Additionally, the filtered material can be suctioned and/or scraped from the smooth surface more easily with the aid of the suction nozzle.

In the context of an ideally smooth surface, the contaminated-air-side surface of the filter pocket in the region of the pocket bottom portion preferably has an area-specific roughness value Sₐ according to DIN EN ISO 25178 of less than 5 nm, particularly preferably less than 1 nm.

The air permeability of the filter pockets in the region of the pocket bottom portion can be achieved, for instance, in that the filter pockets in said region, thus in the region of the pocket base and the legs, are formed from a material which in terms of density and/or composition differs from the material of the filter mats.

The filter pockets in the region of the at least almost air-impermeable pocket bottom portion particularly preferably have a planar and preferably profiled shaped part which extends across the pocket base and the legs, wherein said shaped part is at least almost air-impermeable and preferably is formed from metal, plastics material, or from compressed filter mat material. The filter mats, which are preferably formed from a non-woven, and the planar shaped part can thus either be formed from different materials, or be composed of the same material, in the latter instance however having a dissimilar density. In the latter case, at least almost air-impermeable properties of the shaped part are obtained by compressing the filter mat material.

The at least almost air-impermeable planar shaped part, (hereunder referred to simply as the “shaped part”) can either be disposed as a connection element between the filter mats of two neighboring filter box walls and connect the latter. In this embodiment, the pocket bottom portion has a region in which no filter mat material is present. For example, the pocket base is free of filter mat material, and the filter pocket to this extent in the region of the pocket base is formed by the shaped part. Nevertheless, the filter mats and the shaped part that are to be connected in the region of the legs can overlap at least in regions and be fastened to one another by means of adhesive bonding, for example. When the shaped part is formed from compressed filter mat material, the filter mats and the shaped part can however also at least transition to one another in an almost seamless manner, or be configured so as to be mutually integral.

As an alternative to the embodiment in which the shaped part connects two filter mats, it is also possible for two neighboring filter box walls to support one common filter mat which extends across the pocket bottom portion and in the region of the pocket bottom portion overlaps the shaped part, or is preferably covered by the latter. In this case, the filter pocket in the region of the pocket bottom portion at all times has two layers which are formed by the respective filter mat and by the shaped part.

The filter pockets formed in each case by mutually facing filter box walls of neighboring filter boxes are particularly preferably not open only on the upstream side but also at the top and/or the bottom. The terms “top” and “bottom” herein refer to the air purification device in the assembled state. In filter pockets open at the bottom it is possible for the suction nozzle for changing from one filter pocket to a neighboring filter pocket to be moved through below that filter box that separates the two filter pockets. In other words: the suction nozzle in one filter pocket is moved downward until said suction nozzle is situated outside the filter pocket and can be moved from the one filter pocket below the intervening filter box into a neighboring filter pocket. This has the advantage that a plurality of filter pockets can be cleaned down by way of the single suction nozzle, and the suction nozzle to this end has to be moved only in two spatial dimensions. In filter pockets that are open at the top, the changeover of the suction nozzle between filter pockets can take place in an analogous manner above the filter boxes.

Filter pockets open at the top and/or the bottom moreover have the advantage that comparatively large accumulations of dust and textile fibers, which by virtue of the size thereof cannot be suctioned off, can be scraped off the filter pocket walls toward the top or the bottom by means of the nozzle. The scraped-off fiber tails which drop by virtue of gravity can be collected in a collection chamber positioned below the filter pockets, for example, and be removed from the latter in the course of cleaning that is periodically carried out. This thus counteracts any blocking of the suction nozzle, which in turn significantly reduces the susceptibility to defects of the filter cleaning installation.

In filter pockets that are open at the top and/or the bottom, the suction nozzle can thus be moved from one filter pocket into a neighboring filter pocket without said suction nozzle to this end having to be reversed out of the filter pockets, as according to DE 3830461, for instance (thus moved in upstream direction). This has the advantageous effect that no additional space for driving out the suction nozzle is required upstream of the filter boxes, and therefore the use of filter boxes having a larger longitudinal extent, that is to say filter boxes which extend far into the contaminated air chamber, is enabled without having to increase the dimensions of the contaminated air chamber to this end.

The movement of the suction nozzle above or below the filter boxes from one filter pocket into the next is preferably performed by moving the carriage having the vertical rail fastened thereto along the horizontal rail. In terms of a filter pocket changeover of the suction nozzle above and/or below the filter boxes, as well as in terms of potential drive and control variants of the movement of the suction nozzle, reference is made to the content of international patent application WO 2016/091270, pages 14-17, filed by the applicant, and the disclosure of said patent application is explicitly incorporated by reference. Nevertheless, it is theoretically conceivable that the suction nozzle for the filter pocket changeover is pivoted out of the filter pocket about a horizontal pivot axis, moved along the horizontal rail to the neighboring filter pocket, and is pivoted inward into the latter.

In so far as the design embodiment of the suction nozzle is concerned, the latter is typically configured as a hollow member and preferably has a preferably at least almost planar nozzle base, as well as two nozzle side walls which preferably project from said nozzle base in an at least almost orthogonal manner and which have in each case one suction opening which preferably neighbors the nozzle base. A suction opening which neighbors the nozzle base is in particular advantageous with a view to cleaning the base below the filter boxes. The suction opening is particularly preferably configured so as to be slot-shaped, or as a row of bores, and is directed onto the surface of the filter mat so as to achieve an ideally intense and precise suction effect.

The suction nozzle on the downstream-side end thereof can furthermore have a scraping brush by means of which filtered material that has accumulated in the pocket bottom portion can be removed.

In order for the brush to be able to reach the pocket base in the pocket bottom, the length of the suction nozzle (including an optionally present scraping brush) is preferably chosen such that said length at least almost corresponds to the depth of the filter pockets (measured perpendicularly to the longitudinal plane). Or in other words, the length and width of the suction nozzle is preferably adapted to the depth and the width of the pocket bottom portion. The nozzle can thus suction off filtered material that has accumulated in the pocket bottom and optionally scrape said filtered material from the filter pocket walls by means of scrapers.

In so far as the depth of the filter pockets is concerned, comparatively narrow and deep filter pockets are preferable in comparison to comparatively wide and shallow filter pockets, since the filter-active face can be increased on account thereof. Therefore, the depth of the filter pockets is preferably at least double the width of the filter pockets at the upstream-side open end thereof, said width being measured perpendicular to the depth.

According to one preferred embodiment, the support frame is specified for being disposed on a floor area having a floor opening that opens into a collection chamber, wherein the floor opening is preferably disposed below the filter boxes. The region of the collection chamber that adjoins the floor opening herein can be used as a maneuvering space for the suction nozzle so as to be able to move the latter below the filter boxes from one filter pocket into a neighboring filter pocket. Floor area which is open below the filter boxes moreover has the advantage that comparatively large accumulations of dust and textile fibers, which by virtue of gravity drop from the filter walls, can accumulate in the collection chamber and be removed from there in the course of periodically carried out cleaning. Blocking of the suction nozzle is thus counteracted, which in turn significantly reduces the susceptibility to defects of the filter cleaning installation.

The air purification plant in the above embodiment preferably comprises an outfeed installation which is specified for being disposed in the collection chamber or so as to adjoin the latter, and for feeding filter material that has accumulated in said collection chamber out of the latter. The outfeed installation preferably comprises a worm conveyor or a suction installation. The latter can moreover serve for suctioning filtered material (that is to say dirt particles to be removed from the contaminated air) through the floor opening into the collection chamber.

Furthermore, a collection funnel which is trough-shaped or in the direction of the collection chamber tapers downward in a conical or pyramidal manner can be disposed so as to be preferably directly contiguous to the mouth of the floor opening, said collection funnel, optionally conjointly with a suction installation, enabling filtered material that has been separated at the filter mats to be directed onward in a targeted manner into the collection chamber. The collection funnel in one embodiment can for instance lead into a collection box which below the floor area preferably extends in the direction of the clean air chamber and at the clean-air-side is accessible for periodic emptying.

The collection chamber can alternatively be configured as an open return-air duct which is preferably provided below the contaminated air chamber, in particular so as to be directly contiguous to the floor area therebelow, and serves for feeding the contaminated air, for instance from an adjacent machine room, into the contaminated air chamber, this enabling particularly space-saving disposal of the air purification plant in an industrial enterprise. The contaminated air chamber and the return-air duct are particularly preferably separated only by the floor area. The contaminated air by way of one or a plurality of openings in the floor area (for example in the form of a floor grate) can thus make its way from the return-air duct into the contaminated air chamber. The air infeed opening herein is preferably at least partially formed by the mentioned floor opening below the filter boxes.

The present invention will be described in more detail hereunder by means of the figures. In the figures, in a purely schematic manner:

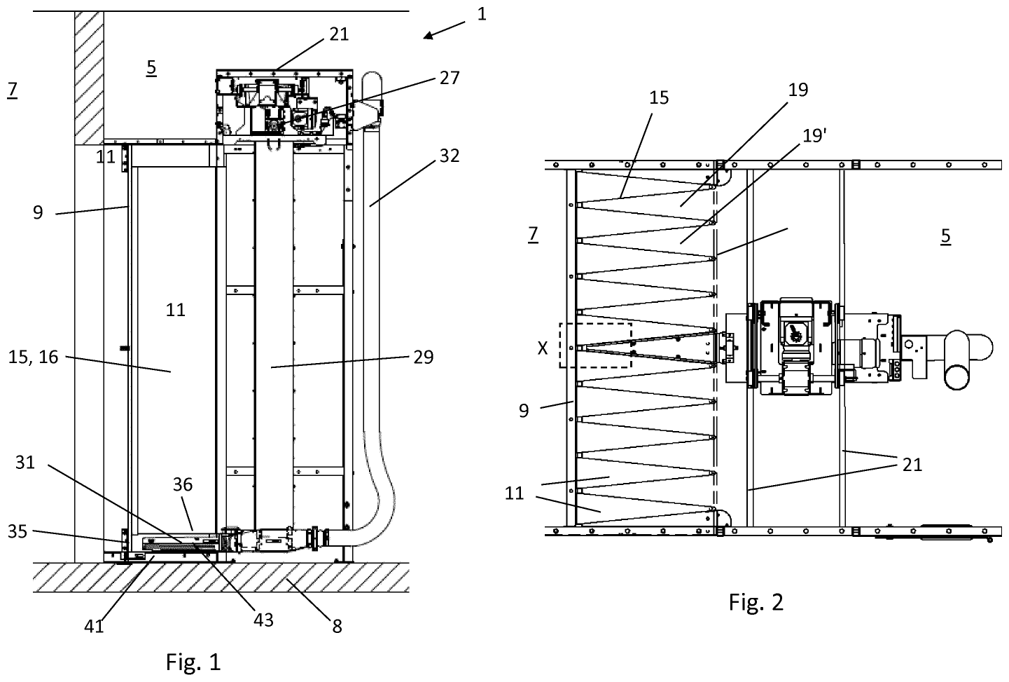

FIG. 1 in a lateral view shows a section through an air purification plant according to the invention, having a plurality of filter boxes which are held on a support frame and in each case have two filter box walls, as well as a filter cleaning installation comprising a suction nozzle for cleaning the filters;

FIG. 2 in a plan view shows the air purification plant shown in FIG. 1;

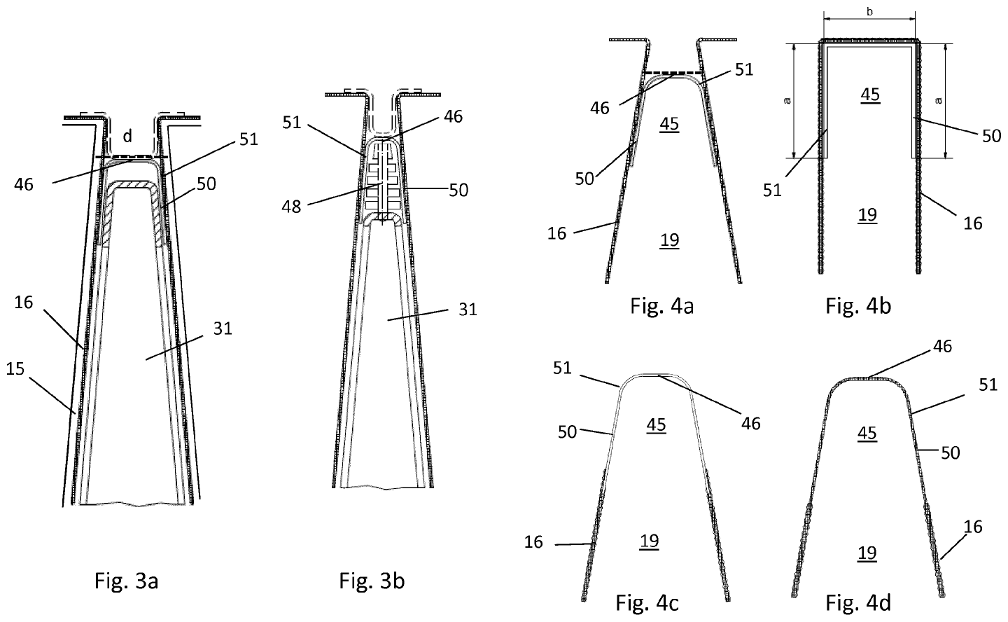

FIG. 3a in an enlarged illustration shows a horizontal section through a pocket bottom portion including the suction nozzle situated in the filter pocket;

FIG. 3b in an enlarged illustration shows a horizontal section through a pocket bottom portion, including an alternative embodiment of a suction nozzle having a scraping brush situated in the filter pocket;

FIGS. 4a-d show in each case a horizontal section through a pocket bottom portion of a filter pocket, wherein various variants of embodiment are shown;

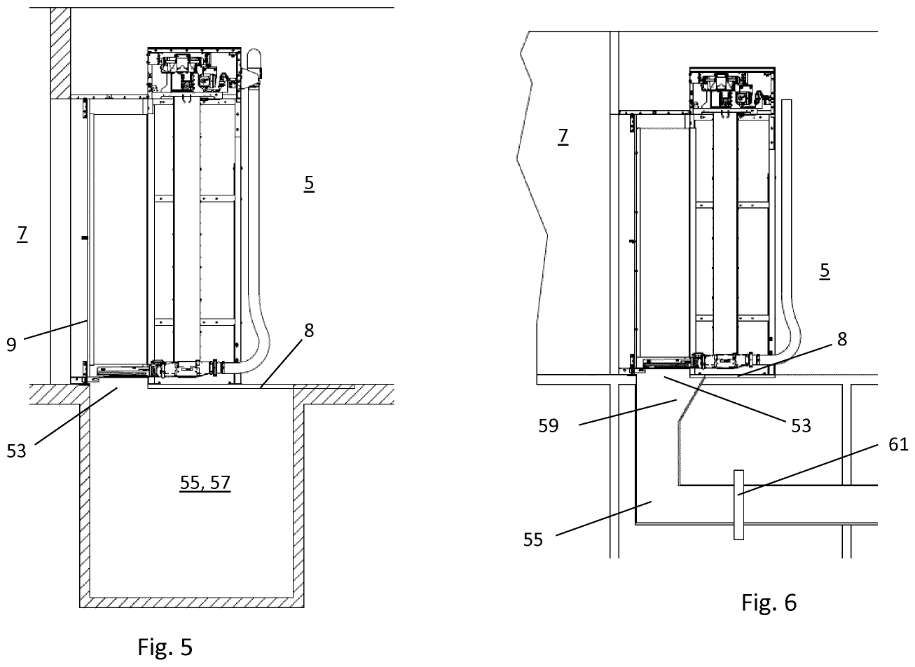

FIG. 5 in a lateral view shows a section through a second embodiment of the air purification plant, in which a floor opening which opens into a return-air duct is present below the filter boxes;

FIG. 6 in a lateral view shows a section through an alternative embodiment of the air purification plant from FIG. 5, in which the floor opening opens into a collection funnel;

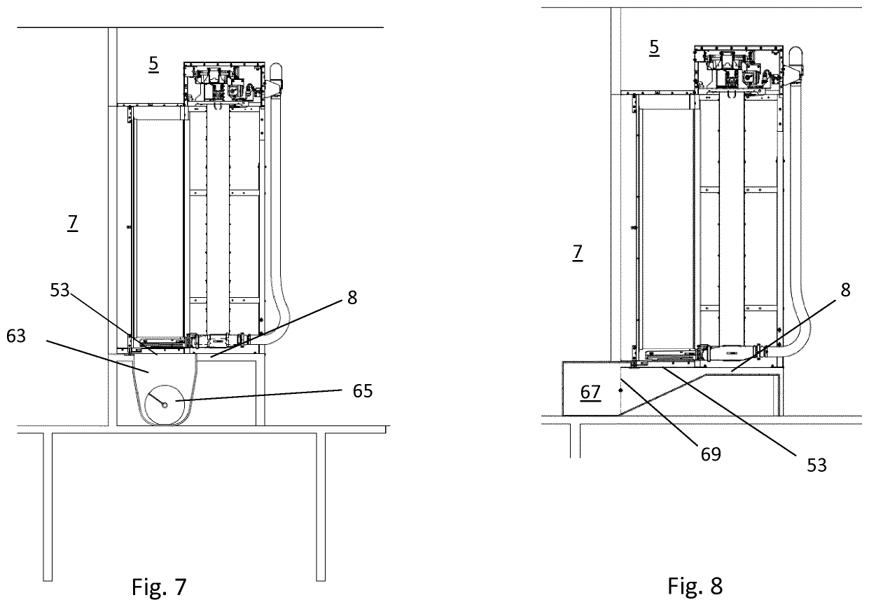

FIG. 7 in a lateral view shows a section through a further alternative embodiment of the air purification plant from FIG. 5, in which the floor opening opens into a collection trough having a worm conveyor disposed therein; and

FIG. 8 in a lateral view shows a section through a further alternative embodiment of the air purification plant from FIG. 5, in which the floor opening opens into a collection box.

As an introduction it is to be noted that identical parts in alternative embodiments are provided with the same reference signs or the same component references, respectively.

The air purification plant 1 illustrated in FIG. 1 serves for separating contaminants from the air, in particular textile contaminants from the exhaust air of industrial textile manufacturing or textile processing enterprises. In such enterprises, the air has typically to be continuously purified of dust and fiber fly (fiber fragments, textile remnants, fiber flakes, etc.) which is created on textile machines, spinning machines, weaving or knitting machines in operation.

The air purification plant 1 has a partition wall 3 which spatially separates a contaminated air chamber 5, disposed upstream, from a clean air chamber 7, disposed downstream. The air purification plant 1 is disposed on a floor area 8. The terms “upstream” and “downstream” refer at all times to the direction of the airflow which from sides of the contaminated air chamber 5 flows through filter-active portions (also referred to as filter faces) of the partition wall 3 into the clean air chamber 7.

The air to be purified is suctioned, for example from a machine room of a textile processing plant, and flows through an air infeed opening (not visible in FIG. 1) into the contaminated air chamber 5 from the front (or from below, as is shown in FIG. 5), is then purified by the air purification plant 1, and subsequently makes its way into the clean air chamber 7, from where the purified air can again be discharged into the machine room or outward into the environment. The air to be purified in the flow direction can be conveyed in a manner known per se (for example by air-conveying means not illustrated, such as a ventilator, a blower, or the like) from the contaminated air chamber 5 in the (downstream) direction of the clean air chamber 7.

The partition wall 3 comprises a support frame 9 which defines a longitudinal plane and on which a plurality of filter boxes 11 which in the direction of the contaminated air chamber 5 project from the support frame 9 are held, or in particular screw-fitted to said support frame 9. Said filter boxes 11 are disposed behind one another in a row on the support frame 9 and have in each case two planar filter box walls 15 which from the support frame 9 extend into the contaminated air chamber 5 and converge upstream at a vertical edge (see also FIG. 2). Said filter box walls 15 which in the plan view extend along the legs of an equilateral triangle (see FIG. 2), in the embodiment shown simultaneously comprise the filter-active faces which are covered with a filter material, in particular a non-woven, and therefore are henceforth referred to as “filter mats” 16. The filter boxes 11 upstream of the support frame 9 are thus delimited by the filter box walls 15. Moreover, the filter boxes 11 at the top and the bottom are closed in an air-tight manner by a base plate or cover plates 18, respectively, (see FIG. 2). By contrast, the filter boxes 11 in the region of the support frame 9 per se are open, that is to say said filter boxes 11 at the support frame 9 open into the clean air chamber 7 disposed downstream.

A respective filter pocket 19 is formed by in each case two mutually facing filter box walls 15 of neighboring filter boxes 11, said filter pocket 19 by contrast to the filter boxes 11 being delimited by the filter box walls 15 only at the downstream side, or being open at the upstream side as well as at the top and the bottom, respectively.

The air purification plant 1 furthermore comprises a horizontal rail 21 which is disposed above a horizontal plane which is defined by the upper end 23 of the filter boxes 11 and extends so as to be parallel with the longitudinal direction of the support frame 9. The horizontal rail 21 comprises two guide rails 25 which are disposed so as to be mutually parallel and along which a carriage 27 is guided so as to be movable in a reciprocating manner in the horizontal direction (see FIG. 2). A vertical rail 29 is moreover fastened to the carriage 27, said vertical rail 29 being disposed upstream of the partition wall 3 or the filter boxes 11, respectively. When the carriage 27 is moved along the horizontal rail 21, the vertical rail 29 fastened to the carriage 27 thus also moves conjointly with said carriage 27. A suction nozzle 31 is guided on the vertical rail 29, said suction nozzle 31 by way of an exhaust-air hose 32 being connected to a low-pressure source (not shown) and for cleaning down the filter mats 16 of a filter pocket 19 in the respective filter pocket 19 being moved in a reciprocating manner in the vertical direction. The suction nozzle 31 to this extent can either carry out vertical stroke movements along the vertical rail 29, or by moving the carriage 27 can be moved conjointly with the vertical rail 29 in the horizontal direction along the horizontal rail 21.

In the embodiment shown in FIG. 1, the support frame 9 having the filter boxes 11 fastened thereto is positioned on the floor area 8, and said support frame 9 has a base strip 35 which on the lower side adjoins the filter boxes 11 and on the other side adjoins the floor area 8. The filter boxes 11, or the filter box walls 15 thereof, respectively, in the embodiment shown are held exclusively by the support frame 9 and are not in contact with the floor area 8. This means that, apart from the support frame 9, no additional supporting elements for the filter boxes 11 are present at the base (as can also be seen in FIG. 3). The lower side 36 of the filter boxes 11 in the vertical direction is thus spaced apart from the floor area 8, wherein said base spacing corresponds approximately to the height of the base strip 35. This permits the suction nozzle 31 to maneuver below the filter boxes 11, so as to change from one filter pocket 19 into a neighboring filter pocket 19′. The suction nozzle 31 in FIG. 1 is situated in a lower terminal position in which said suction nozzle 31 can move below the filter boxes 11, or in the free lower intermediate space 41 between the floor area 8 and the lower side 36 of the filter boxes 11, respectively. The manner in which the movement of the suction nozzle 31 can be specifically controlled is described in detail in the international patent application WO 2016/091270, pages 14-17, filed by the applicant, and the disclosure in this regard is explicitly incorporated in the present application. When the suction nozzle 31 in the course of such a filter pocket changeover is moved in the free lower intermediate space 41, the floor area 8 below the filter boxes 11 can simultaneously be cleaned. This prevents that dust and fiber material separated on the filter mats 16 can accumulate on the floor area 8 and congestion and/or blockages of the suction nozzle 31 are able to arise on account thereof. Moreover, separate cleaning of the floor area 8, for example using an additional vacuum, can be dispensed with, this permitting a substantial saving in terms of time in the air purification process.

As can be seen from FIG. 2, the filter boxes 11 when viewed in the plan view have an in particular triangular or trapezoidal external shape which tapers at the upstream side. In view of the fact that the filter pockets 19 are in each case formed by mutually facing filter box walls 15 of neighboring filter boxes 11, the filter pockets 19 correspondingly also have a V-shaped horizontal cross-section which tapers at the downstream side, in particular a triangular or trapezoidal cross-section. The external shape, or the horizontal cross-sectional face, of the filter boxes 11, respectively, is preferably consistent across the entire height of the filter boxes 11. However, rectangular cross-sectional shapes such as shown in FIG. 4b, for instance, would also be conceivable instead of triangular filter boxes 11 and filter pockets 19.

The filter boxes 11 are preferably fastened so as to be individually replaceable on the support frame 9 and have a stable filter box frame on which the assigned filter mats 16 are held. The filter boxes 1 and/or the filter mats 16 can thus be individually removed and replaced when required. Moreover, the filter boxes 11 which are disposed so as to be closer to the center on the support frame 9 and therefore are often more heavily stressed can thus be replaced earlier when required than the peripheral filter boxes 11 which are typically less stressed.

The fragment from FIG. 2 identified by X is illustrated in an enlarged manner in FIGS. 3a and 3b and in the horizontal cross-section shows in isolation a downstream-side end 40 of a filter pocket 19 having a suction nozzle 31 disposed therein. The suction nozzle 31, corresponding to the shape of the filter pockets 19, has a triangular or trapezoidal cross-section which tapers in the direction of a downstream-side end 42. Suction slots 43 (see FIG. 1) through which filtered material that has accumulated on the filter mats 16 can be suctioned off are configured along the side walls of said suction nozzle 31. Each filter pocket 19 has at least one downstream-side, at least almost air-impermeable pocket bottom portion 45 which is delimited by a pocket base 46 as well as by two legs 50 that along a respective filter box wall 15 project in each case from the patent base 46 in the direction of the contaminated air chamber 5, and which extends across the entire height of the respective filter pocket 19. By virtue of the at least almost air-impermeable properties of the pocket bottom portion 45, this region of the filter pocket 19 that is more difficult to access for the suction nozzle 31 is not filter-active, on account of which the quantity of filtered material that is deposited there can be heavily reduced. Furthermore, dirt particles adhere to the contaminated-air-side wall regions in the pocket bottom portion 45 significantly less easily (in comparison to the filter mats 16), which is why said dirt particles can be removed by the suction nozzle 31 by simple scraping, and to this extent no suction activity by the suction nozzle 31 is required in the pocket bottom portion 45. For this reason, the suction slots 43 of the suction nozzle 31 in both embodiments shown in FIGS. 3a and 3b do not reach quite as far as the downstream-side end 42 of the respective suction nozzle 31, but only to the height of the pocket bottom portion 45. The suction nozzle 31 shown in FIG. 3b at the downstream-side end thereof has a scraping brush 48 for cleaning the contaminated-air-side surface 49 in the pocket bottom portion 45. Such a scraping brush 48 is particularly advantageous in tight filter pockets 19 (thus at an opening angle of less than 45°, for instance).

As can be seen from FIGS. 4a-d, the at least almost air-impermeable pocket bottom portion 45 in terms of the cross-sectional shape thereof can be of different design embodiments. However, said pocket bottom portion according to the invention at all times has the following three properties or features, respectively:
a) the material from which the pocket bottom portion 45 is formed is at least almost air-impermeable and thus at least almost not filter-active;
b) the contaminated-air-side surface 49 in the pocket bottom portion 45 is to be as “smooth” as possible so that fibers and dust adhere as poorly as possible on the surface 49;
c) the legs 50 are at least the length of the spacing d between the filter box walls 15 that form the filter pocket 19, said spacing d being measured parallel with the longitudinal plane at the pocket base 46 (see FIG. 4b). This condition at least almost defines that the legs 50 have a specific minimum length.

The term “measured along the pocket base 46” herein means that the spacing d of the filter box walls 15 is measured along a straight line which in the cross section of the filter pocket 19 runs along the pocket base 46, or in the case of a curved pocket base 46 forms the tangent. As can be seen in FIGS. 3a, 3b, and 4a, the pocket base 46 herein does not mandatorily have to be disposed at the height of the downstream-side ends 40 of the filter box walls 15 but can also be offset further upstream.

The at least almost air-impermeable pocket bottom portion 45 in the embodiments shown in FIGS. 3a-b and FIGS. 4a-c comprises a planar-shaped part 51 which is at least almost air-impermeable and can be made from metal or plastics material, for instance. The shaped part 51 and the filter mats 16 herein have dissimilar material compositions. As is shown in FIG. 4d, the filter pocket 19 in the region of the pocket bottom portion 45 can alternatively also be formed from the same material as the filter mats 16, however differ in terms of the density of the material. The at least almost air-impermeable properties of the filter mat material are maintained by squeezing or compressing, respectively, said filter mat material in the region of the pocket bottom portion 45.

The shaped part 51, for example in the region of the legs 50, can be positioned on the filter mats 16 of the associated filter box walls (see FIGS. 3a, 3b, and 4a) and be fastened to said filter box walls by means of, for instance, adhesive bonding, welding (in particular press-welding methods such as resistance welding, ultrasonic welding, friction welding or cold press-welding), or by textile joining methods (for example stitching or loop-forming methods). Furthermore, the shaped part 51 can also be fastened to the external frame of the filter box walls 15 by screw-fitting. In this case, the screws and/or nuts used to this end are preferably countersunk in the shaped part 51 so that no parts which project into the pocket bottom portion 45 and on which dirt particles can accumulate and impede the cleaning of the contaminated-air-side surfaces are present on the contaminated air side.

In a manner differing from the variant shown in FIG. 4a, for instance, an embodiment in which a filter mat extends from one filter box wall 15 across the entire pocket bottom portion 45 to the other filter box wall 15 and in the region of the pocket bottom portion is covered by the at least almost air-impermeable planar shaped part 51 is illustrated in FIG. 4b. The shaped part 51 is configured as a metal sheet, for example, which covers the filter mat in the pocket bottom portion 45.

As is shown in FIG. 4c, it is also possible for the filter mats 16 to extend only to the pocket bottom portion 45, or the shaped part 51, respectively, or overlap the shaped part 51 at least only at the upstream-side ends of the legs 50 of said shaped part 51. FIG. 4d furthermore shows an embodiment in which the filter pocket 19 within as well as outside the pocket bottom portion 45 is formed by one filter mat or a plurality of filter mats 16, the filter mat/filter mats 16 in the pocket bottom portion 45 however being squeezed and compressed in such a manner that said filter mat/filter mats 16 are at least almost air-impermeable in said region.

The filter pockets 19 either can have an at least almost V-shaped cross-section in which the filter box walls enclose an angle (FIGS. 3a, 3b, 4a, 4c, 4d), or can comprise a U-shaped cross-section (FIG. 4b).

The floor area 8 on which the support frame 9 is supported can be closed (as is shown in FIG. 1). In this case, contaminated air is directed to the filter boxes 11 from the front, that is to say so as to be orthogonal to the horizontal support frame plane. Filtered material that has dropped from the filter mats 16 herein can be suctioned from the floor area 8 by the suction nozzle 31 which is moved through below the filter boxes 11. Alternatively, the support frame 9, as is shown in FIGS. 5 to 8, can be disposed on a floor area 8 having a floor opening 53 that opens into a collection chamber 55, wherein the floor opening 53 is disposed below the filter boxes 11. The region of the collection chamber 55 that adjoins the floor opening 53 herein can be utilized as a maneuvering space for the suction nozzle 31, so as to be able to move the latter below the filter boxes 11 from one filter pocket 19 into a neighboring filter pocket 19′. Furthermore, comparatively large accumulations of dust and textile fibers can be manually removed from the collection chamber 55 in the course of periodically carried out cleaning or be automatically removed therefrom. Blocking of the suction nozzle 31 is thus counteracted, this in turn significantly reducing the susceptibility to defects of the filter cleaning installation. In the embodiments shown in FIGS. 6 to 8, contaminated air above the floor area 8 flows into the contaminated air chamber 5, while said contaminated air, as will be explained further hereunder, in the embodiment according to FIG. 5 is directed into the contaminated air chamber 5 from below through openings in the floor area 8.

The collection chamber 55 in FIG. 5 is configured as an open return-air duct 57 which so as to adjoin directly below the floor area 8 extends in the direction of the contaminated air chamber 5. The return-air duct 57 serves for feeding the contaminated air, for instance from an adjacent machine room (not shown) into the contaminated air chamber 5, this enabling particularly space-saving disposal of the air purification plant in an industrial enterprise. The floor area 8, apart from the floor opening, preferably has at least one further opening, or is at least in portions configured as a floor grate, so as to conjointly with the floor opening 53 to enable the feeding of contaminated air from the return-air duct 57 into the contaminated air chamber 5.

As is shown in FIG. 6, a collection funnel 59 which tapers downward in the direction of the collection chamber 55 in a conical or (truncated) pyramidal manner and which conjointly with the suction installation 61 enables a targeted, in particular pneumatic, discharge of filtered material separated on the filter mats 16 can be disposed

so as to be directly adjacent to the mouth of the floor opening 53.

In an embodiment illustrated in FIG. 7, the floor opening 53 opens into a trough-shaped collection funnel in which a worm conveyor 65 is disposed. Filtered material that has accumulated in the collection funnel 63 can be fed out of the collection funnel 63 with the aid of the worm conveyor 65. For example, the filtered material with the aid of the worm conveyor is conveyed to one side of the collection funnel 63, and is pneumatically fed out from there.

In the variant shown in FIG. 8, the collection chamber is configured as a collection box 67, or the collection funnel 59 opens into a collection box 67, respectively, the latter extending in the downstream direction into the clean air chamber 7 and having a closable flap 69. The flap 69 during periodically performed emptying of the collection box 67 is closed so that access to the collection box 67 from the clean-air-chamber-side is possible during the operation of the air purification plant. An intermittent or continuous air flow can facilitate the introduction of filtered material into the collection box 67.

1. An air purification plant, having
a partition wall for spatially separating a contaminated air chamber, disposed upstream, from a clean air chamber, disposed downstream;
wherein the partition wall comprises a support frame that defines a longitudinal plane, and a plurality of filter boxes that project from the support frame in the direction of the contaminated air chamber;
the filter boxes are in each case open toward the clean air chamber disposed downstream, and have at least one filter box wall which supports a filter mat;
mutually facing filter box walls of neighboring filter boxes form in each case one filter pocket which is open on the upstream side, and each filter pocket has a depth measured perpendicularly to the longitudinal plane;
and a filter cleaning installation
having a horizontal rail on which a carriage is guided so as to be movable in a reciprocating manner in the horizontal direction;
a vertical rail which is fastened to the carriage; and
a suction nozzle which by way of a downstream-side free end protrudes into a filter pocket, has a suction opening, and for cleaning the filter mats in a respective filter pocket at the vertical rail is guided so as to be movable in a reciprocating manner in the vertical direction as well as so as to be movable from one filter pocket to a neighboring filter pocket,
wherein
the filter pockets have in each case one downstream-side, at least almost air-impermeable pocket bottom portion which is formed by a pocket base as well as two legs that from the pocket base project in each case along a respective filter box wall in the direction of the contaminated air chamber, and which extends across the entire height of the respective filter pocket;
wherein the legs are at least the length of a spacing between the filter box walls that form the respective filter pocket, the spacing being measured parallel with the longitudinal plane at the pocket base.

2. The air purification plant as claimed in claim 1, wherein the filter pockets have a trapezoidal, V-shaped, or U-shaped cross-section.

3. The air purification plant as claimed in claim 1, wherein the legs of the pocket bottom portion are in each case at least 10%, preferably at least 20%, particularly preferably at least 45%, longer than the spacing.

4. The air purification plant as claimed in claim 1, wherein the contaminated-air-side surface of the filter pocket within the pocket bottom portion has a lower area-specific roughness value Sₐ according to DIN EN ISO 25178 than outside the pocket bottom portion, and preferably has an area-specific roughness value Sₐ of less than 5 nm, preferably less than 1 nm.

5. The air purification plant as claimed in claim 1, wherein the filter pockets in the region of the pocket bottom portion are formed from a material which in terms of density and/or composition differs from the material of the filter mats.

6. The air purification plant as claimed in claim 5, wherein the filter pockets in the region of the pocket bottom portion have a planar and preferably profiled shaped part which extends across the pocket base and the legs and which is at least almost air-impermeable and preferably is formed from metal, plastics material, or from compressed filter mat material.

7. The air purification plant as claimed in claim 5, wherein the planar, at least almost air-impermeable, shaped part connects the filter mats of two neighboring filter box walls and in each case overlaps the filter mats to be connected, or at least almost seamlessly adjoins the respective filter mats.

8. The air purification plant as claimed in claim 5, wherein two neighboring filter box walls support one common filter mat which extends across the pocket bottom portion and in the region of the pocket bottom portion is preferably covered by the planar, at least almost air-impermeable, shaped part.

9. The air purification plant as claimed in claim 1, wherein the filter boxes are open at the top and/or bottom, and the suction nozzle is movable from one filter pocket to a neighboring filter pocket below and/or above the filter box that separates the two filter pockets.

10. The air purification plant as claimed in claim 1, wherein the suction nozzle has a nozzle base, two nozzle side walls which preferably project at least almost orthogonally from the nozzle base, as well as two suction openings which extend along the nozzle side walls.

11. The air purification plant as claimed in claim 1, wherein the suction nozzle on the downstream-side end thereof has a scraping brush for cleaning the contaminated-air-side surfaces in the pocket bottom portion.

12. The air purification plant as claimed in claim 1, wherein the depth of the filter pockets is at least double the length of the spacing of the associated filter box walls on the upstream-side open end of the filter pocket.

13. The air purification plant as claimed in claim 1, wherein the support frame supporting the filter boxes is specified for being supported on a floor area which has a floor opening, wherein the floor opening is located below the filter boxes and opens into a collection chamber, and
in that the air purification plant has an outfeed installation which is specified for being disposed in the collection chamber and for feeding accumulated filtered material out of the collection chamber.

14. The air purification plant as claimed in claim 13, wherein the outfeed installation comprises a worm conveyor or a suction installation.

15. The air purification plant as claimed in claim 13, comprising a collection funnel which is trough-shaped or in the direction of the collection chamber tapers downward in a conical or pyramidal manner and which is preferably disposed so as to be contiguous to the floor opening.
